(19) United States
(12) Patent Application Publication
(10) Pub. No.: US 2026/0245810 A1
(43) Pub. Date: Aug. 20, 2026

(54) ROTATION SHAFT STRUCTURE, TRANSMISSION SYSTEM, OPERATION MECHANISM AND SWITCHING DEVICE ASSEMBLY

(71) Applicant: Schneider Electric Industries SAS, Rueil-Malmaison (FR)

(72) Inventors: Xiaoqiang Li, Shanghai (CN); Baoyun Bi, Shanghai (CN)

(73) Assignee: Schneider Electric Industries SAS, Rueil-Malmaison (FR)

(21) Appl. No.: 19/534,796

(22) Filed: Feb. 10, 2026

(30) Foreign Application Priority Data
Feb. 14, 2025 (CN) 202520237856.4

(51) Int. Cl. H01H 3/42

(52) U.S. Cl. CPC H01H 3/42

(57) ABSTRACT

The present disclosure relates to a rotation shaft structure, a transmission system, an operation mechanism, and a switching device assembly. A rotation shaft is rotatably installed on a housing and capable of rotating between a first rotation position and a second rotation position, the rotation shaft is further configured to be capable of translating inward from an initial position toward a first translating position and a second translating position, the first translating position is located between the initial position and the second translating position, at the first rotation position, the rotation shaft is configured to be capable of translating only from the initial position to the first translating position, and at the second rotation position, the rotation shaft is configured to be capable of translating from the initial position to the second translating position. The rotation shaft structure further includes a first microswitch, a second microswitch, and a third microswitch.

### CLAIM OF PRIORITY

This application claims the benefit of Chinese Patent Application No. 2025202378564 entitled “ROTATION SHAFT STRUCTURE, TRANSMISSION SYSTEM, OPERATION MECHANISM AND SWITCHING DEVICE ASSEMBLY” by X. Li and B. Bi filed on February 14, 2025, which is herein incorporated by reference in its entirety.

### TECHNICAL FIELD

The present disclosure relates to a rotation shaft structure, a transmission system, an operation mechanism, and a switching device assembly.

### BACKGROUND

In some rotation shaft structures, in some cases, axial free movement of the rotation shaft is needed, and at the same time it is needed to limit the axial movement of the rotation shaft. If the structure of the rotation shaft is complicated, it is difficult to realize such a function. In particular, it is also needed to realize the function of preventing accidental touch, that is, to prevent the accidental rotation or translation of the rotation shaft from causing further action of the device to which it is applied.

### SUMMARY

To overcome the abovementioned problems, the present application provides a rotation shaft structure that can include a rotation shaft, rotatably installed on a housing and capable of rotating between a first rotation position and a second rotation position, the rotation shaft being further configured to be capable of translating inward from an initial position toward a first translating position and a second translating position in a direction along a rotational axis of the rotation shaft, the first translating position being located between the initial position and the second translating position. At the first rotation position, the rotation shaft is configured to be capable of translating only from the initial position to the first translating position, and at the second rotation position, the rotation shaft is configured to be capable of translating from the initial position to the second translating position. The rotation shaft structure can further include a first microswitch, fixedly arranged on the housing, the first microswitch is positioned to be triggered by being pressed by a part of the rotation shaft upon the rotation shaft being at the first rotation position; a second microswitch, fixedly arranged on the housing, the second microswitch is positioned to be triggered by being pressed by a first part of the rotation shaft structure upon the rotation shaft being at a first translating position, and to be triggered by being pressed by a second part of the rotation shaft structure different from the first part upon the rotation shaft being at a second translating position; and a third microswitch, fixedly arranged on the housing, the third microswitch is positioned to be triggered by being pressed by another part of the rotation shaft upon the rotation shaft being at the second rotation position.

Additionally and/or alternatively, the rotation shaft structure can further include a first stopper and a second stopper fixedly installed on the housing with the second stopper being positioned more inward than the first stopper. The rotation shaft can include a first engagement member and a second engagement member with the second engagement member being positioned more inward than the first engagement member. Upon the rotation shaft being at the first rotation position, the first stopper and the first engagement member can at least partially overlap along the rotational axis, so that upon the rotation shaft being translated to the first translating position, the first stopper abuts against the first engagement member. Upon the rotation shaft being at the second rotation position, the first stopper and the first engagement member may not overlap along the rotational axis, and the second stopper and the second engagement member can at least partially overlap along the rotational axis, so that upon the rotation shaft being translated to the second translating position, the second stopper abuts against the second engagement member.

Additionally and/or alternatively, the rotation shaft structure can include a first plat, fixed to the rotation shaft and extending perpendicular to the rotational axis and a second plate rotatably installed to the rotation shaft, extending parallel to the first plate, and positioned closer to the second microswitch than the first plat with the second plate being configured to be rotatable between a first posture and a second posture with respect to the first plate. Upon the rotation shaft being at the first rotation position, the second plate and the second microswitch can at least partially overlap along the rotational axis, so that upon the rotation shaft being at the first translating position, the second microswitch can be triggered by being pressed by the second plate. Upon the rotation shaft being at the second rotation position, the second plate and the second microswitch may not overlap along the rotational axis, and the first plate and the second microswitch can at least partially overlap along the rotational axis, so that upon the rotation shaft being at the second translating position, the second microswitch is triggered by being pressed by the first plate.

Additionally and/or alternatively, during a rotation of the rotation shaft in the second translating position from the second rotation position to the first rotation position, the second plate is capable of being externally stopped and thereby rotating relative to the first plate in a direction opposite to a rotation direction of the rotation shaft, so that the second plate moves from the first posture to the second posture, and after the rotation shaft rotates to the first rotation position and returns to the initial position, the second plate rotates back to the first posture relative to the first plate under an action of a reset member of the second plate.

Additionally and/or alternatively, the rotation shaft can include a first protrusion and a second protrusion with the first protrusion and the second protrusion being arranged in a longitudinal direction parallel to the rotational axis. A size of the first protrusion in a direction perpendicular to the longitudinal direction can be smaller than a size of the second protrusion in the direction perpendicular to the longitudinal direction.

The present disclosure further provides a transmission system that can include the abovementioned rotation shaft structure with the rotation shaft of the rotation shaft structure being a driving member. The Transmission system can include a driven member rotatably arranged on the housing with the driving member being operatively coupled to the driven member, so that upon the driving member moving, the driven member can be driven to move.

The present disclosure further provides an operation mechanism for a switching device, the operation mechanism being installed to the switching device. The operation mechanism can include the abovementioned transmission system; an operation handle fixedly installed on the driving member and being capable of rotating between a closed position and an opening position while indicating the closed position and the opening position; and a driven member operatively connected to the driving member at an aspect and operatively connected to the switching device at another aspect with the first rotation position of the driving member corresponding to a closed state of the switching device and the second rotation position of the driving member corresponding to an open state of the switching device.

Additionally and/or alternatively, the driven member can include a first groove and a second groove which are in communication with each other, the first groove being located at a first end side and the second groove being located at a second end side. Further, a size of the first groove can be configured to accommodate the first protrusion but not the second protrusion, and a size of the second groove can be configured to accommodate the second protrusion. At the first rotation position of the driving member, upon the driving member being translated to the first translating position, the first protrusion can be inserted into the second groove. At the second rotation position of the driving member, upon the driving member being translated to the second translating position, the second protrusion can be inserted into the second groove.

Additionally and/or alternatively, the first microswitch, the second microswitch, and the third microswitch can all be electrically connected to an electronic controller of the switching device.

The present disclosure further provides a switching device assembly with the switching device assembly including a switching device and the abovementioned operation mechanism installed to/on the switching device.

### BRIEF DESCRIPTION OF DRAWINGS

The above and other features and advantages of exemplary embodiments of the present disclosure will become more apparent from the following detailed description taken in conjunction with the accompanying drawings, which are for illustrative purposes only and are not intended to limit the scope of the present disclosure in any way, wherein:

FIG. 1 shows a schematic diagram of an example switching device assembly according to the present disclosure.

FIG. 2 shows an enlarged view of detail A in FIG. 1 to show a rotation shaft structure in which a rotation shaft is at a first rotation position and an initial position and a switching device is in the closed state.

FIG. 3 shows a schematic diagram after the rotation shaft is translated from the initial position to the first translating position while the rotation shaft is still at the first rotation position during the switching of the switching device from a closed state to an open state with a first protrusion being inserted into a first groove. At the second rotation position of the driving member, upon the driving member being translated to the second translating position, the second protrusion is inserted into the second groove.

FIG. 4 shows a schematic diagram during switching of a switching device from a closed state to an open state upon a rotation shaft being moved from a first rotation position to a second rotation position with the rotation shaft not being rotated to the second rotation position.

FIG. 5 shows a schematic diagram of rotating a rotation shaft to a second rotation position and moving the rotation shaft back to the initial position from the first translating position during the switching of a switching device from a closed position to an opening position and the switching device being in the open state.

FIG. 6 shows a schematic diagram after a rotation shaft is translated from the initial position to the second translating position while the rotation shaft is still at the second rotation position during the switching of the switching device from the open state to the closed state with a second protrusion being inserted into a second groove.

FIG. 7 shows a perspective view of an example rotation shaft.

FIG. 8 shows a perspective view of an example driven member.

Identical reference numerals have been used, where possible, to designate identical elements that are common to the figures. However, elements disclosed in one example may be beneficially utilized on other examples without specific recitation. The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Moreover, where considered appropriate, reference labels have been repeated among the figures to indicate corresponding or analogous elements.

### DETAILED DESCRIPTION

Reference will now be made to the drawings wherein like reference numerals identify ‎‎‎similar structural features or aspects of the subject disclosure. For purposes of ‎‎explanation and ‎illustration, and not limitation, various examples are described herein. Unless defined otherwise, all technical and scientific terms used herein have the same ‎‎‎meaning as commonly understood by one of ordinary skill in the art to which this ‎‎disclosure ‎belongs. Any methods and materials similar or equivalent to those ‎‎described herein can ‎also be used in the practice or testing of the present disclosure. ‎ It should be noted that the described example (s) are a part of the embodiment of the present disclosure and may not represent the whole embodiment.

It must be noted that as used herein and in the appended claims, the singular forms “a,” ‎‎‎‎“an,” and “the” include plural referents unless the context clearly dictates otherwise. ‎‎Thus, for ‎example, reference to “a stopper” includes a plurality of such stoppers and ‎‎reference to “the microswitch” ‎includes reference to one or more microswitches and equivalents ‎‎thereof known to those skilled in the art, ‎and so forth.

Compared with the examples shown in the attached drawings, the feasible embodiments within the scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The words “first, “second,” and similar words used in the specification and claims of the patent application of the present disclosure do not indicate any order, quantity, or importance but are only used to distinguish different components. When the number of parts is not specified, the number of parts can be one or more. Similarly, similar words such as “a,” “an,” and “the” do not necessarily refer to quantity limitation. Similar words such as “including” or “containing” mean that the elements or objects appearing before the word cover the elements or objects listed after the word and their equivalents, without excluding other elements or objects. “Up,” “Down,” “Left,” and “Right” are only used to indicate the relative orientation relationship when the equipment is used or the orientation relationship shown in the attached drawings. When the absolute position of the described objects changes, the relative orientation relationship may also change accordingly.

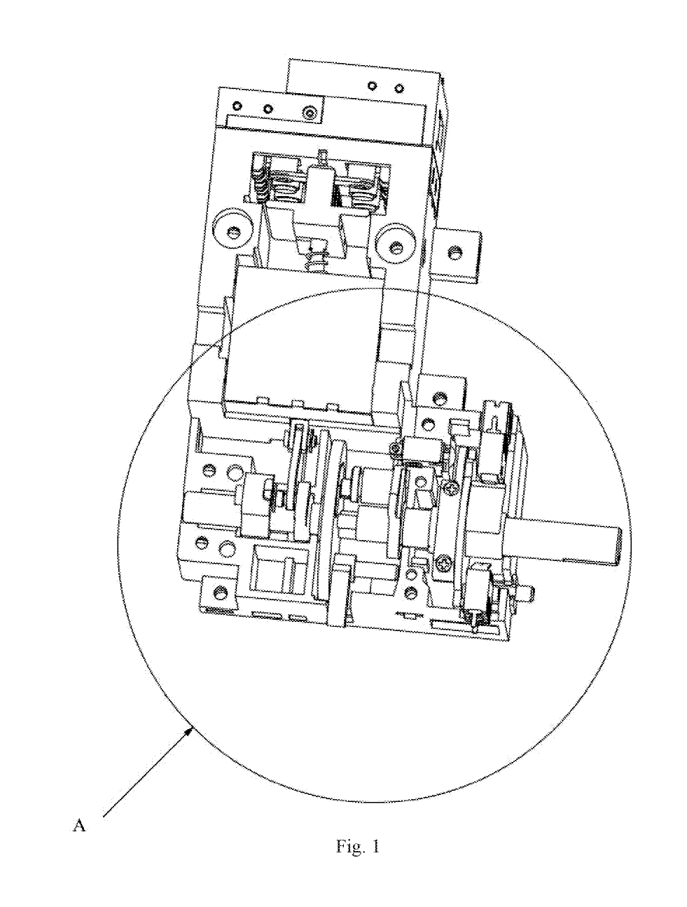

FIG. 1 shows a schematic diagram of an example switching device assembly according to the present disclosure, which includes an operation mechanism and a switching device. The switching device can be any form of switch. The operation mechanism is installed on the switching device for operating the switching device to switch between the closed state and the open state.

The operation mechanism includes a transmission system and an operation handle. The transmission system includes a rotation shaft structure 1 and a driven member 2, and the driven member 2 can rotate under the driving of the rotation shaft structure 1, which is described in detail below.

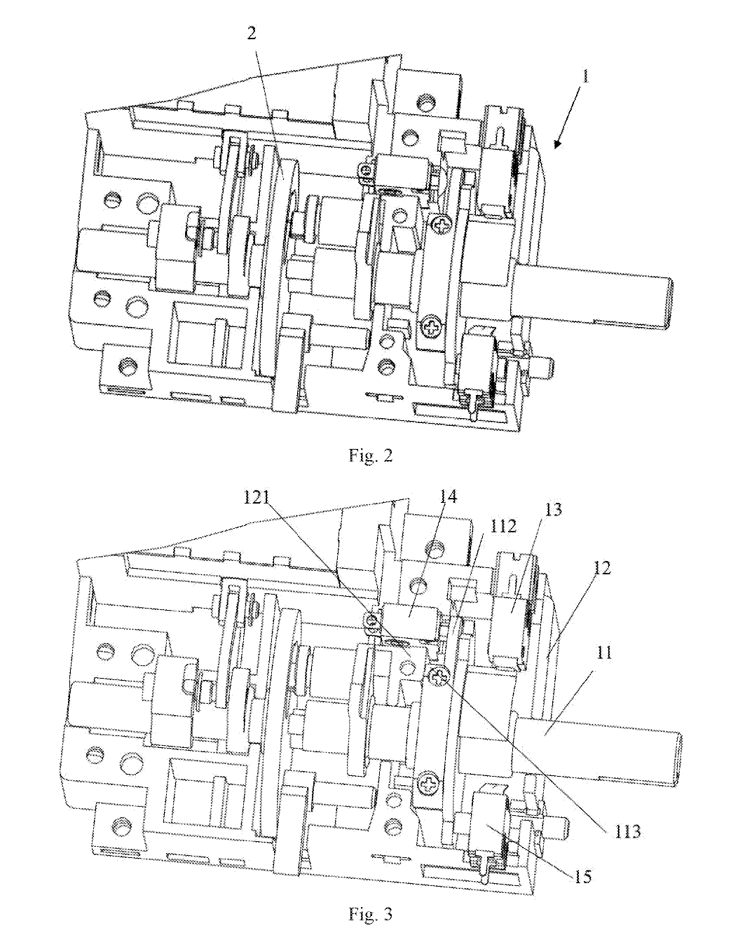

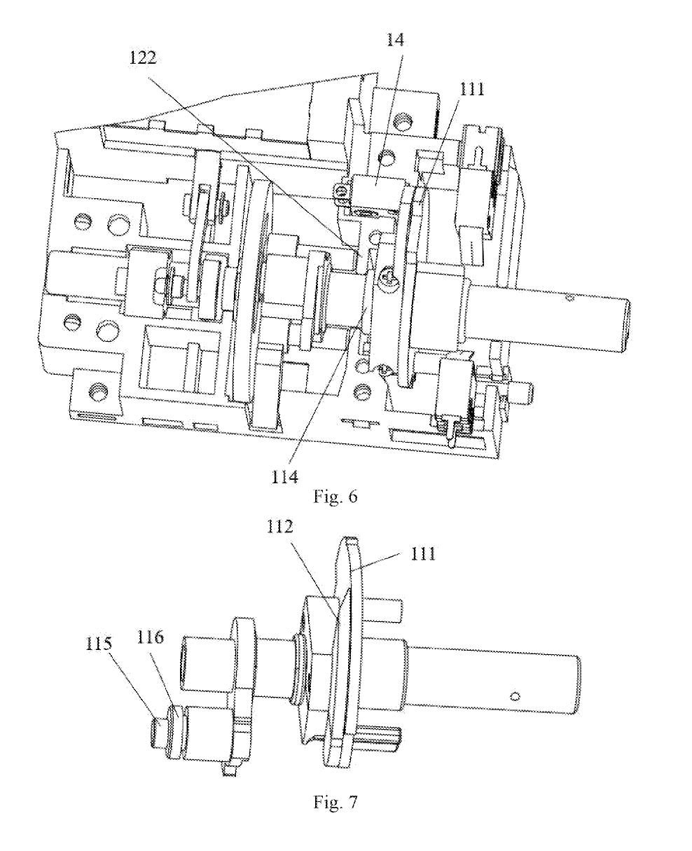

The rotation shaft structure 1 is described below. As illustrated by FIG. 2, the rotation shaft structure 1 includes a rotation shaft 11, which is also called a driving member. The rotation shaft 11 is rotatably installed on a housing 12 and is capable of rotating between a first rotation position (as illustrated by FIG. 2) and a second rotation position (as illustrated by FIG. 5). In addition to a rotational movement, the rotation shaft 11 is also configured to be capable of translating inward from an initial position (as illustrated by FIG. 2) to a first translating position (as illustrated by FIG. 3) and a second translating position (as illustrated by FIG. 6) in a direction along a rotational axis of the rotation shaft 11, the first translating position is between the initial position and the second translating position. That is, a distance of the rotation shaft 11 from the initial position to the first translating position is smaller than a distance from the initial position to the second translating position.

The rotation shaft structure 1 further includes a first microswitch 13 (also called a closing microswitch when used in a switching device) fixedly arranged on the housing 12, and the first microswitch 13 is positioned to be triggered by being pressed by a part of the rotation shaft 11 upon the rotation shaft 11 being at the first rotation position.

A second microswitch 14 is fixedly arranged on the housing. The second microswitch 14 is positioned to be triggered by being pressed by a first part of the rotation shaft 11 upon the rotation shaft 11 being at the first translating position, and to be triggered by being pressed by a second part of the rotation shaft 11 different from the first part upon the rotation shaft 11 being at the second translating position.

Similar to the first microswitch 13, a third microswitch 15 (also called an opening microswitch when used in a switching device) is fixedly arranged on the housing 12, and the third microswitch 15 is positioned to be pressed by another part of the rotation shaft 11 upon the rotation shaft 11 being at the second rotation position.

As illustrated by FIG. 2, the rotation shaft 11 is in the initial position and the first rotation position. Upon the rotation shaft structure 1 being used in a switching device, the switching device is in a closed state in this case. FIG. 3 shows that the rotation shaft 11 is translated from the initial position to the first translating position, but still at the first rotation position. In this case, a part of the rotation shaft 11 presses against the second microswitch 14, thereby triggering the second microswitch 14.

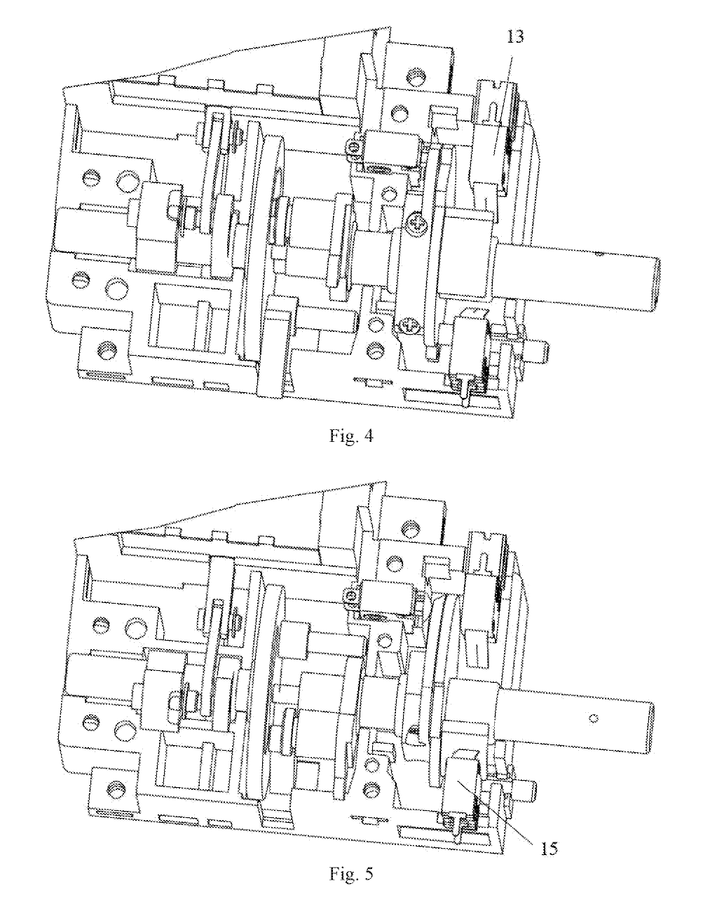

In this example, the rotation shaft structure 1 includes a first plate 111 (labeled in FIG. 6) fixedly installed to the rotation shaft 11 and extending perpendicular to the rotational axis; a second plate 112 rotatably installed to the rotation shaft 11, extending parallel to the first plate 111, positioned closer to the second microswitch 14 than the first plate 111, and configured to be rotatable between a first posture and a second posture with respect to the first plate 111. As illustrated by FIG. 3, the second plate 112 of the rotation shaft 11 presses the second microswitch 14. That is, upon the rotation shaft 11 being at the first rotation position, the second plate 112 and the second microswitch 14 at least partially overlap along the rotational axis, so that upon the rotation shaft 11 being at the first translating position, the second microswitch 14 is triggered by being pressed by the second plate 112. Next, the rotation shaft 11 rotates from the first rotation position to the second rotation position, as illustrated by FIG. 4. In this case, the rotation shaft 11 rotates to a position between the first rotation position and the second rotation position, and the rotation shaft 11 is out of abutment with the first microswitch 13. As the rotation shaft 11 continues to rotate, as illustrated by FIG. 5, the rotation shaft 11 rotates to the second rotation position and moves back to the initial position from the first translating position. In this case, the rotation shaft 11 presses the third microswitch 15. When being used in the switching device, in this case, the switching device is in the open state.

FIG. 6 shows that the rotation shaft 11 is translated from the initial position to the second translating position, but still at the second rotation position. In this case, the first plate 111 of the rotation shaft 11 presses against the second microswitch 14 to trigger the second microswitch 14. That is, upon the rotation shaft 11 being at the second rotation position, the second plate 112 and the second microswitch 14 do not overlap along the rotational axis, and the first plate 111 and the second microswitch 14 at least partially overlap along the rotational axis, so that upon the rotation shaft 11 being at the second translating position, the second microswitch 14 is triggered by being pressed by the first plate 111.

The process of the rotation shaft 11 rotating from the second rotation position to the first rotation position is similar to the process of the rotation shaft 11 rotating from the first rotation position to the second rotation position, which will not be described here.

During the rotation of the rotation shaft 11 in the second translating position from the second rotation position to the first rotation position, the second plate 112 can be externally stopped (such as a stopper provided on the housing 12) and rotated relative to the first plate 111 in a direction opposite to the rotation direction of the rotation shaft 11, so that the second plate 112 moves from the first posture to the second posture, and after the rotation shaft 11 rotates to the first rotation position and returns to the initial position, the second plate 112 is under the action of a reset member (such as a spring, not shown) of the second plate 112.

During the rotation of the rotation shaft 11 in the first translating position from the first rotation position to the second rotation position, the second plate 112 is not blocked, thus maintaining the first posture with respect to the first plate 111.

In order to define the first translating position and the second translating position of the rotation shaft 11, the rotation shaft structure 1 of the present disclosure further includes a first stopper 121 and a second stopper 122 which are fixedly installed on the housing 12, and the second stopper 122 is positioned more inward than the first stopper 121. The rotation shaft 11 includes a first engagement member 113 and a second engagement member 114, and the second engagement member 114 is positioned more inward than the first engagement member 113.

Upon the rotation shaft 11 being at the first rotation position, the first stopper 121 and the first engagement member 113 at least partially overlap along the rotational axis, so that upon the rotation shaft 11 being translated to the first translating position, as illustrated by FIG. 3, the first stopper 121 abuts against the first engagement member 112, thereby defining the first translating position.

Upon the rotation shaft 11 being at the second rotation position, the first stopper 121 and the first engagement member 113 do not overlap along the rotational axis, and the second stopper 122 and the second engagement member 114 at least partially overlap along the rotational axis, so that upon the rotation shaft 11 being translated to the second translating position, as illustrated by FIG. 6, the second stopper 122 abuts against the second engagement member 114, thereby defining the second translating position.

As illustrated by FIG. 7, the rotation shaft 11 also comprises a first protrusion 115 and a second protrusion 116, the first protrusion 115 and the second protrusion 116 are arranged in a longitudinal direction parallel to the rotational axis, and a size of the first protrusion 115 in a direction perpendicular to the longitudinal direction is smaller than a size of the second protrusion 116 in the direction perpendicular to the longitudinal direction.

As mentioned earlier, the present disclosure also provides a transmission system, including the rotation shaft structure 1 with the rotation shaft 11 of the rotation shaft structure 1 being a driving member. A driven member 2 is rotatably arranged on the housing 12, and the driving member is operatively coupled to the driven member 2 so that the driven member 2 can be driven to move upon the driving member moving.

The transmission system can be applied to a switching device as a part of the operation mechanism of switching device. In addition to the transmission system, the operation mechanism can include an operation handle (not shown), which can be fixedly installed on the driving member, and can be capable of rotating between a closed position and an opening position (while indicating the closed position and the opening position). The driven member 2 can be operatively connected to the driving member, and the driven member 2 can be operatively connected to the switching device. The first rotation position of the driving member can correspond to the closed state of the switching device, and the second rotation position of the driving member can correspond to the open state of the switching device.

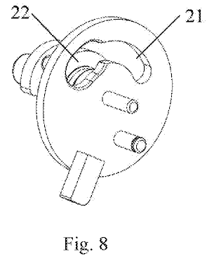

As illustrated by FIG. 8, in the operation mechanism for switching device, the driven member 2 can also include a first groove 21 and a second groove 22 communicating with each other. The first groove 21 is located at a first end side and the second groove 22 is located at a second end side. The size of the first groove 21 can be configured to accommodate the first protrusion 115 but not the second protrusion 116, and the size of the second groove 22 can be configured to accommodate the second protrusion 116. Thus, at the first rotation position of the driving member, upon the driving member being translated to the first translating position, the first protrusion 115 can be inserted into the second groove 22. At the second rotation position of the driving member, upon the driving member being translated to the second translating position, the second protrusion 116 can be inserted into the second groove 22.

In particular, the operation mechanism of the present disclosure is a bidirectional operation mechanism. Thus, it is possible to manually actuate the operation handle to realize the switching-on and switching-off operation of the switching device. It is also possible to realize the switching-off and switching-on operation of the switching device through the operation mechanism inside the switching device itself. In the latter case, the rotation shaft structure 1 and the driven member structure 2 of the present disclosure are particularly beneficial to realize the function of free tripping. That is, the rotation shaft 11 will not hinder the rotation of the driven member driven 2 by the operation mechanism inside the switching device itself.

In the operation mechanism for the switching device, the first microswitch 13, the second microswitch 14, and the third microswitch 15 are all electrically connected to an electronic controller of the switching device. Upon the first microswitch 13 and the second microswitch 14 being triggered at the same time, the first microswitch 13 and the second microswitch 14 send closing signals to the electronic controller of the switching device, and upon the second microswitch 14 and the third microswitch 15 being triggered at the same time, the second microswitch 14 and the third microswitch 15 send opening signals to the electronic controller of the switching device.

In this way, only upon the first microswitch 13 and the second microswitch 14 being triggered at the same time, the electronic controller of the switching device will send out the closing signal, thus preventing the situation that one of the first microswitch 13 and the second microswitch 14 is triggered by misoperation and sends out the closing signal. Similarly, only upon the third microswitch 15 and the second microswitch 14 being triggered at the same time, the electronic controller of the switching device will send out the opening signal, thus preventing the situation that one of the third microswitch 15 and the second microswitch 14 is triggered by misoperation and sends out the opening signal.

The switching device is described herein merely as an example, but those skilled in the art should understand that the rotation shaft structure of the present disclosure is not limited thereto and can also be applied to other scenes that require “double determination” of microswitches.

Although the present disclosure has been described in the specification and illustrated in the drawings on the basis of referring to various embodiments, those skilled in the art can understand that the above-mentioned embodiments are only preferred embodiments, and some technical features in the embodiments may not be necessary for solving specific technical problems. Thus, these technical features may be omitted without affecting the solution of technical problems or the formation of technical solutions. Moreover, the features, elements, and/or functions of one embodiment can be combined or coordinated with those of one or more other embodiments as appropriate.

It is to be understood that the above description is intended to be illustrative and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, this description and the accompanying drawings are to be regarded as illustrative rather than restrictive. The scope of the disclosure should, therefore, be determined with reference to the appended claims, along with the full scope of equivalents to which such claims are entitled.

1. A rotation shaft structure comprising:
a rotation shaft rotatably installed on a housing and capable of rotating between a first rotation position and a second rotation position and translating inward from an initial position toward a first translating position and a second translating position in a direction along a rotational axis of the rotation shaft with the first translating position being located between the initial position and the second translating position, wherein, at the first rotation position, the rotation shaft is capable of translating only from the initial position to the first translating position and, at the second rotation position, the rotation shaft is capable of translating from the initial position to the second translating position;
a first microswitch fixedly arranged on the housing, wherein the first microswitch is positioned to be triggered by being pressed by the rotation shaft upon the rotation shaft being at the first rotation position;
a second microswitch fixedly arranged on the housing, wherein the second microswitch is positioned to be triggered by being pressed by a first part of the rotation shaft upon the rotation shaft being at the first translating position and to be triggered by being pressed by a second part of the rotation shaft different from the first part upon the rotation shaft being at the second translating position; and
a third microswitch fixedly arranged on the housing, wherein the third microswitch is positioned to be triggered by being pressed by the rotation shaft upon the rotation shaft being at the second rotation position.

2. The rotation shaft structure according to claim 1, further comprising:
a first stopper and a second stopper fixedly installed on the housing with the second stopper being positioned more inward than the first stopper; and
a first engagement member and a second engagement member on the rotation shaft with the second engagement member being positioned more inward than the first engagement member.

3. The rotation shaft structure according to claim 2, wherein, upon the rotation shaft being at the first rotation position, the first stopper and the first engagement member at least partially overlap along the rotational axis so that, upon the rotation shaft being translated to the first translating position, the first stopper abuts against the first engagement member, and wherein, upon the rotation shaft being at the second rotation position, the first stopper and the first engagement member do not overlap along the rotational axis and the second stopper and the second engagement member at least partially overlap along the rotational axis so that, upon the rotation shaft being translated to the second translating position, the second stopper abuts against the second engagement member.

4. The rotation shaft structure according to claim 1, further comprising:
a first plate fixed to the rotation shaft and extending perpendicular to the rotational axis; and
a second plate rotatably installed to the rotation shaft, extending parallel to the first plate, and positioned closer to the second microswitch than the first plate, the second plate being configured to be rotatable between a first posture and a second posture with respect to the first plate.

5. The rotation shaft structure according to claim 4, wherein, upon the rotation shaft being at the first rotation position, the second plate and the second microswitch at least partially overlap along the rotational axis so that, upon the rotation shaft being at the first translating position, the second microswitch is triggered by being pressed by the second plate, and wherein, upon the rotation shaft being at the second rotation position, the second plate and the second microswitch do not overlap along the rotational axis and the first plate and the second microswitch at least partially overlap along the rotational axis so that, upon the rotation shaft being at the second translating position, the second microswitch is triggered by being pressed by the first plate.

6. The rotation shaft structure according to claim 5, wherein during a rotation of the rotation shaft in the second translating position from the second rotation position to the first rotation position, the second plate is capable of being externally stopped and thereby rotating relative to the first plate in a direction opposite to a rotation direction of the rotation shaft so that the second plate moves from the first posture to the second posture and, after the rotation shaft rotates to the first rotation position and returns to the initial position, the second plate rotates back to the first posture relative to the first plate under an action of a reset member of the second plate.

7. The rotation shaft structure according to claim 1, wherein the rotation shaft comprises:
a first protrusion and a second protrusion arranged in a longitudinal direction parallel to a rotational axis with a size of the first protrusion in a direction perpendicular to the longitudinal direction being smaller than a size of the second protrusion in the direction perpendicular to the longitudinal direction.

8. A transmission system comprising:
the rotation shaft structure according to claim 1, wherein the rotation shaft of the rotation shaft structure is a driving member; and
a driven member rotatably arranged on the housing,
wherein the rotation shaft is operatively coupled to the driven member so that, upon the rotation shaft moving, the driven member is driven to move.

9. An operation mechanism for a switching device with the operation mechanism being installed to the switching device, wherein the operation mechanism comprises:
the transmission system according to claim 6; and
an operation handle fixedly installed on the rotation shaft and capable of rotating between a closed position and an opening position and indicating the closed position and the opening position.

10. The operation mechanism according to claim 9, wherein the driven member is operatively connected to the driving member at an aspect and operatively connected to the switching device at another aspect, and wherein the first rotation position of the rotation shaft corresponds to a closed state of the switching device and the second rotation position of the rotation shaft corresponds to an open state of the switching device.

11. The operation mechanism according to claim 10, wherein the driven member comprises:
a first groove and a second groove in communication with each other, the first groove being located at a first end side and the second groove being located at a second end side, a size of the first groove being configured to accommodate the first protrusion but not the second protrusion, and a size of the second groove being configured to accommodate the second protrusion.

12. The operation mechanism according to claim 11, wherein, at the first rotation position of the rotation shaft, upon the rotation shaft being translated to the first translating position, the first protrusion is inserted into the second groove, and wherein, at the second rotation position of the rotation shaft, upon the rotation shaft being translated to the second translating position, the second protrusion is inserted into the second groove.

13. The operation mechanism according to claim 12, wherein the first microswitch, the second microswitch, and the third microswitch are each electrically connected to an electronic controller of the switching device.

14. A switching device assembly, wherein the switching device assembly comprises:
a switching device and the operation mechanism according to claim 9 with the operation mechanism being installed to the switching device.

15. A rotation shaft structure comprising:
a rotation shaft configured to rotate between a first rotation position and a second rotation position as well as laterally translate from an initial translating position to a first translating position and a second translating position with the first translating position being located laterally between the initial translating position and the second translating position;
a first microswitch adjacent the rotation shaft and configured to be triggered by engaging the rotation shaft upon the rotation shaft being in the first rotation position;
a second microswitch adjacent the rotation shaft and configured to be triggered by engaging a first part of the rotation shaft upon the rotation shaft being at the first translating position and to be triggered by engaging a second part of the rotation shaft upon the rotation shaft being at the second translating position; and
a third microswitch adjacent the rotation shaft and configured to be triggered by engaging the rotation shaft upon the rotation shaft being at the second rotation position.

16. The rotation shaft structure of claim 15, wherein the rotation shaft is configured to laterally translate only from the initial translating position to the first translating position and, at the second rotation position, from the initial translating position to the second translating position.

17. The rotation shaft structure of claim 15, further comprising:
a first stopper adjacent the rotation shaft;
a second stopper adjacent the rotation shaft and radially inward from the first stopper;
a first engagement member on the rotation shaft; and
a second engagement member on the rotation shaft, wherein the first engagement member extends radially outward from the rotation shaft a greater distance than the first engagement member,
wherein the first stopper and the first engagement member at least partially overlap in response to the rotation shaft being at the first rotation position and the first stopper abuts the first engagement member in response to the rotation shaft being at the first translating position, and
wherein the first stopper and the first engagement member do not overlap and the second stopper and the second engagement member at least partially overlap in response to the rotation shaft being at the second rotation position and the second stopper abuts the second engagement member in response to the rotation shaft being at the second translating position.

18. The rotation shaft structure of claim 15, further comprising:
a first plate on the rotation shaft and extending perpendicular to a rotation axis; and
a second plate on the rotation shaft, extending parallel to the first plate, and positioned closer to the second microswitch than the first plate with the second plage being configured to be rotatable between a first posture and a second posture.

19. The rotation shaft structure of claim 18, wherein the second plate and the second microswitch at least partially overlap in response to the rotation shaft being at the first rotation position and the second microswitch engages the second plate in response to the rotation shaft being at the first translating position, and wherein the second plate and the second microswitch do not overlap and the first plate and the second microswitch at least partially overlap in response to the rotation shaft being at the second rotation position and the second microswitch engages the first plate in response to the rotation shaft being at the second translating position.

20. The rotation shaft structure of claim 15, further comprising:
a first protrusion on the rotation shaft parallel to a rotation axis;
a second protrusion on the rotation shaft parallel to the rotation axis and adjacent to the first protrusion,
wherein a size of the first protrusion perpendicular to the rotation axis is smaller than a size of the second protrusion perpendicular to the rotational axis.
